(19) United States
(12) Patent Application Publication
(10) Pub. No.: US 2004/0120799 A1
(43) Pub. Date: Jun. 24, 2004

(54) Trailer with rotating bed

(76) Inventor: Jack C. Kessler, Delta, UT (US)

Correspondence Address: JACK C. KESSLER, 283 Island Park Drive, Delta, UT, 84624, US

(21) Appl. No.: 10/324,815

(22) Filed: Dec. 20, 2002

(51) Int. Cl. B60P 1/43

(52) U.S. Cl. 414/537

(57) ABSTRACT

A trailer for transporting snowmobiles, all terrain vehicles and other vehicles that are driven onto the trailer and that includes a trailer bed onto which the vehicles are driven, a wheel supported undercarriage beneath the bed, a motor powered drive assembly to fully rotate the bed with respect to the undercarriage and protector/ramps at opposite ends of the trailer bed to provide ramps for driving vehicles on to and off of the trailer bed.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to trailers and is particularly related to trailers used in transporting snowmobiles.

### BRIEF SUMMARY OF THE INVENTION

Snowmobile users frequently use trailers to transport the machines from storage to a use location and return. It is not uncommon that one snowmobile or even as many as four to six machines are transported on a single trailer. Very few snowmobiles are capable of reverse travel so it frequently is a difficult task to load the snowmobile or snowmobiles on a trailer bed such that they can be readily removed. Generally the machines are simply dragged off the trailer when they are unloaded. The machines are heavy and cumbersome and it is not only hard work to drag them from the trailer, but it is also somewhat dangerous, particularly when such procedures may be taking place in snow storms or other inclement weather conditions. Also, it is very common that loading and unloading of the trailer may be taking place in locations affording limited mobility of the trailer or towing vehicle. For example the vehicle and trailer may be driven to the end of a single lane mountain road at which location it is necessary to unload the snowmobiles from the rear of the trailer. Or, the vehicle and trailer may be driven into a parking lot at a ski-resort, where parking space is at a premium and there is no alternative to dragging the snowmobiles from the rear of the trailer.

Trailers have been developed in the past that allow front ramps to be lowered into position allowing snowmobiles to be driven off the trailer at an angle that will afford clearance of the towing vehicle. This, of course requires side clearance alongside the tow vehicle to permit the machines to be run off the trailer. Often, such side clearance is not available and the user of the trailer must resort to dragging the transported snowmobiles from the rear of the trailer.

Principal objects of the present invention are to provide a trailer that can be used to transport snowmobiles, all-terrain vehicles and the like and that will provide for easy loading and unloading of the trailer.

Still other objects are to provide a trailer that will permit snowmobiles and ATV's to be driven onto the trailer and off of the trailer even when the vehicles do not have a reverse drive.

It is yet another object of the invention to allow loading and unloading of a trailer from any desired location around the trailer and from ground level or from a hillside, snow bank or other elevated terrain feature at the loading and unloading site.

Principal features of the invention include a trailer with a rigid, supporting, wheeled undercarriage and a trailer bed supported by bearings carried by the undercarriage. An electric motor rotates the bed on the bearings, through sprockets and a drive chain. An electrical switch operates to turn the motor on and off and a locking assembly is provided to secure the bed against rotation relative to the undercarriage during travel of the trail t.

Other objects and features of the invention will become apparent to those skilled in the art to which the invention pertains from the following detailed description and drawings, disclosing what is presently contemplated as being the best mode of the invention.

### DRAWINGS

In the drawings:

FIG. 1 is a perspective view of the trailer of the invention;

FIG. 2 a similar view with the bed of the trailer rotated;

FIG. 3, a pictorial view showing the undercarriage and trailer bed;

FIG. 4, an enlarged view of the drive motor for the bed;

FIG. 5, an enlarged view of the front end of the undercarriage and trailer bed, shown fragmentarily, and the locking assembly;

FIG. 6, a reduced top plan view of the trailer;

FIG. 7, a side elevation view;

FIG. 8, an enlarged side elevation view of the coupling between trailer bed and drive sprocket; and

FIG. 9, a transverse section, taken on the line 9-9 of FIG. 7.

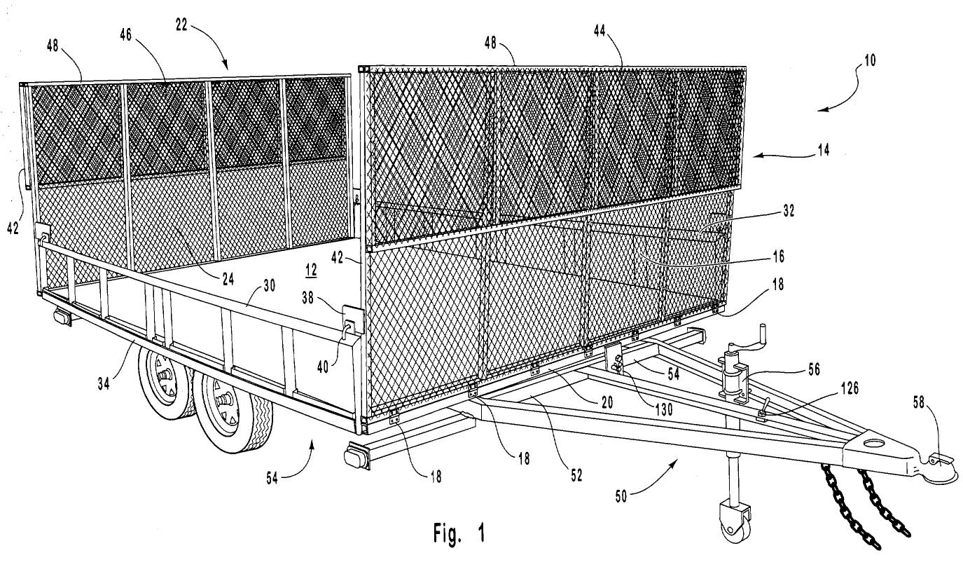

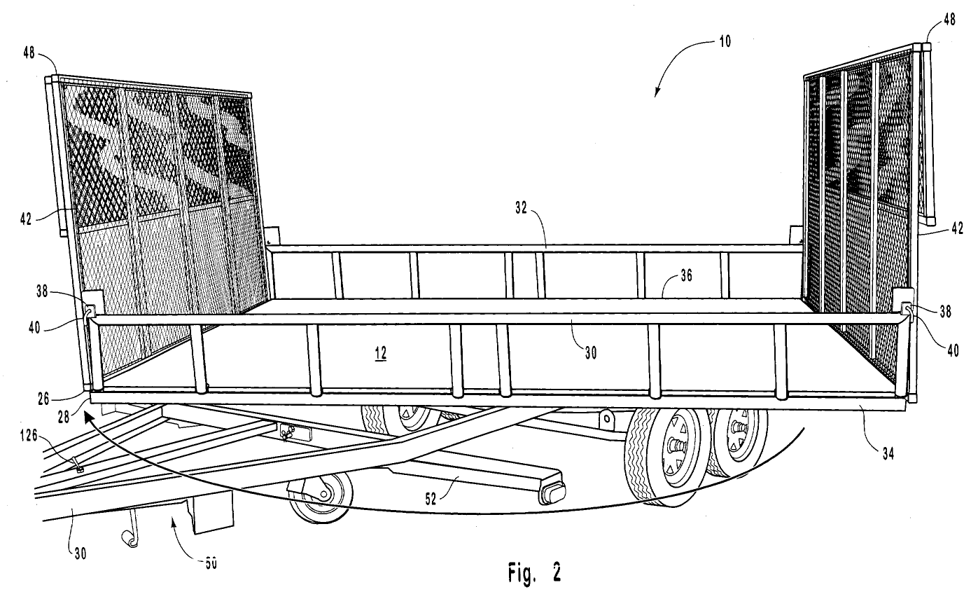

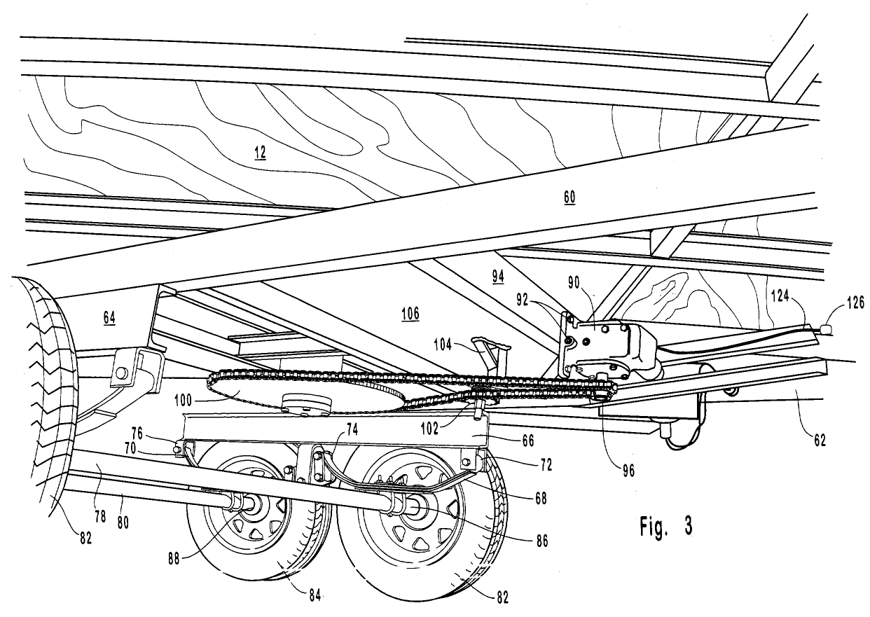

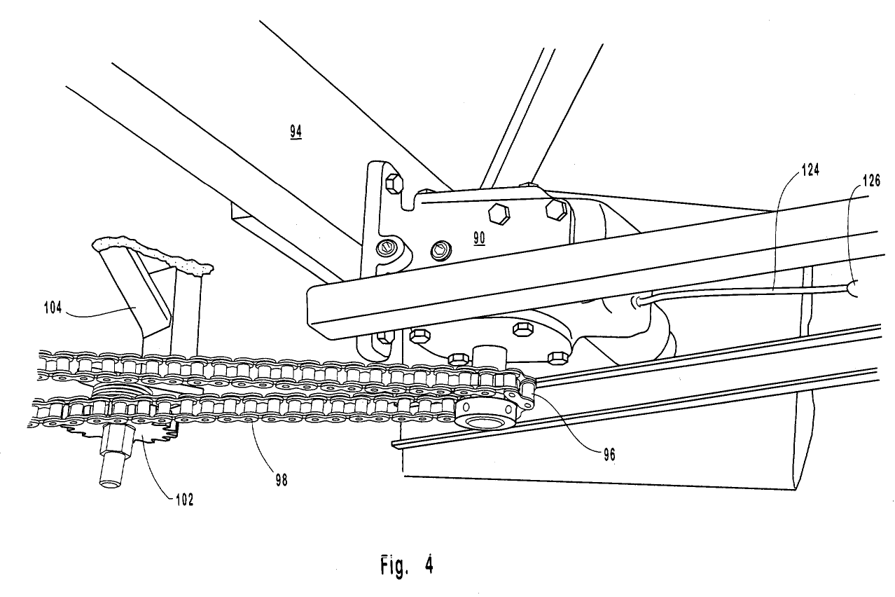

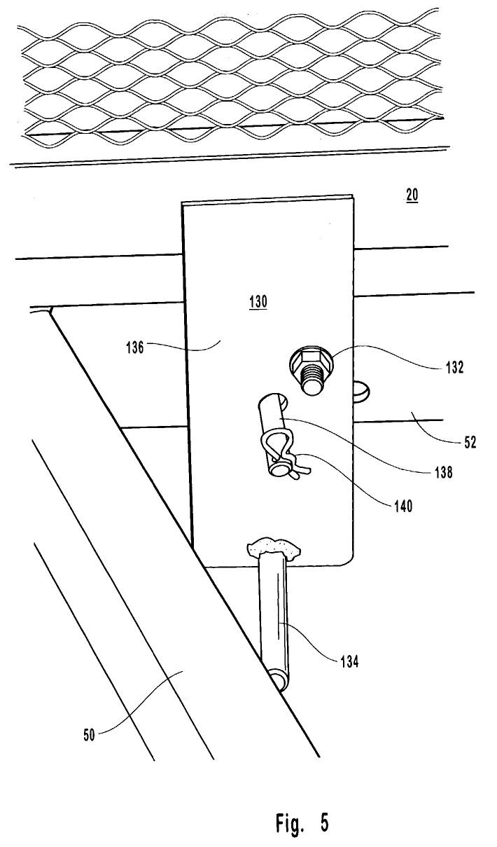

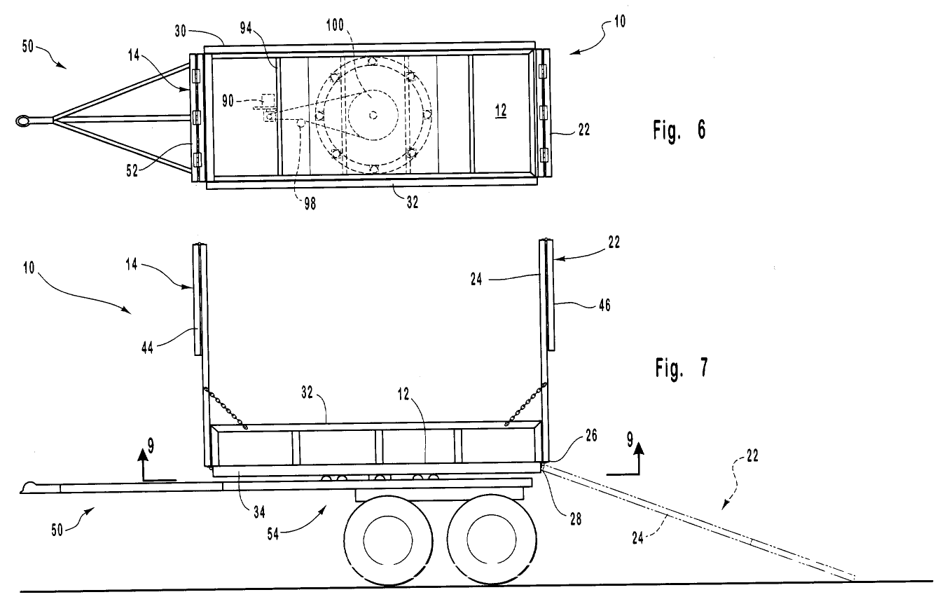

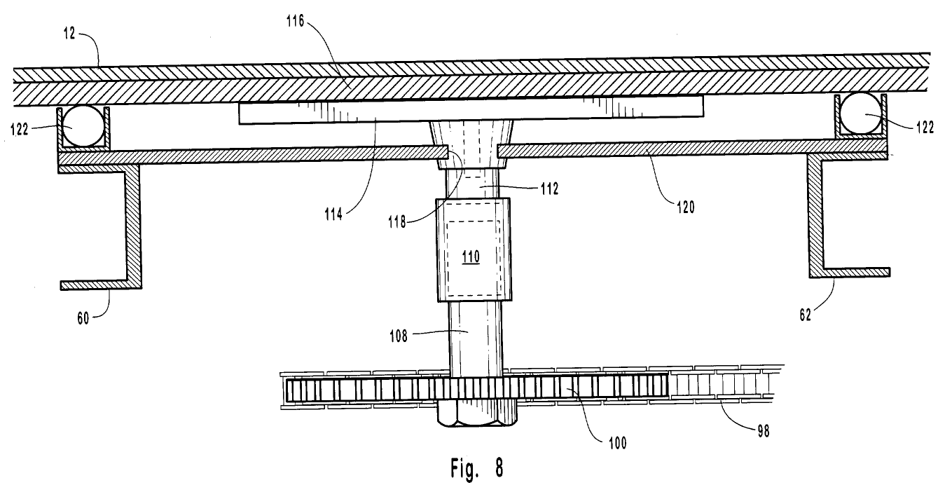

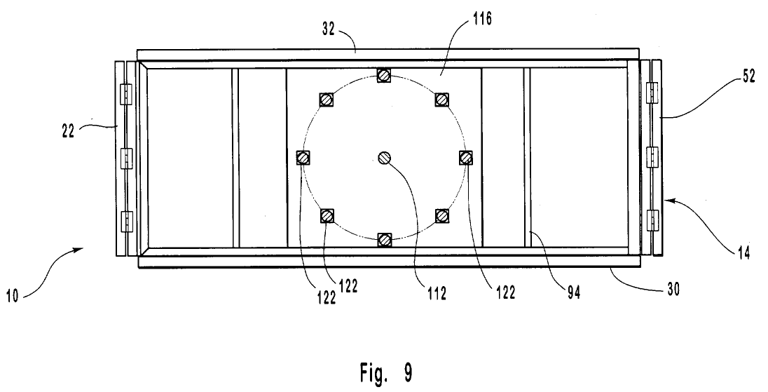

### DETAILED DESCRIPTION

Referring now to the drawings:

In the illustrated embodiment, the trailer of the invention is shown generally at 10. Trailer 10 includes a trailer bed 12 with a front protector/ramp 14 having a section 16 pivotally connected by hinges 18 to a front edge 20 of the bed 12. A rear protector/ramp 22 has a section 24 that is similarly pivotally hinge connected at 26 to the rear edge 28 of the bed 12.

Side rails 30 and 32 project upwardly from rails 34 and 36 at opposite sides of the bed 12. Plates 38 project upwardly from ends of side rails 30 and 32 and locking pins 40 are inserted through plates 38 and frames 42 of the protector/ramps 14 and 22. Upper sections 44 and 46 of the protector/ramps 14 and 22 are respectively hinged at 48 to the sections 16 and 24.

The protector/ramps 14 and 22 are locked in a to the side rails in a raised position when snowmobiles are positioned on the trailer bed. In the raised position the protector/ramps hold the snowmobiles on the trailer and the front protector/ramp 14 protects the snowmobiles from slush and Either debris thrown up by the tow vehicle wheels. The protector/ramps 14 and 22 are pivoted downwardly and sections 44 and 46 are pivoted to form extensions of the sections 16 and 24 that will serve as extended access ramps for movement of snowmobiles onto and off the trailer bed. A trailer tongue 50 is connected to and projects from a front rail 52 of an undercarriage 54 beneath the trailer bed 12. The usual trailer jack 56 is fixed to tongue 50 and a hitch coupler 58 is mounted to the end of the tongue remote from the front rail 52 for attachment to a tow vehicle (not shown).

Undercarriage 54 further includes a pair of spaced apart long rails 60 and 62, a pair of spaced apart short rails 64 and 66 respectively welded to long rails 60 and 62. A pair of leaf springs 68 and 70 are suspended by spring hangars 72, 74 and 76 from each of the short rails and a pair of roles 78 and 80 with wheels 82 and 84 on the ends thereof are secured t) the springs by clamps 86 and 88.

A gear motor 90 is bolted at 92 to a cross beam 94 interconnecting the long rails 60 and 62 and the output shaft of the motor has a small sprocket 96 thereon. A chain 98 passes around small sprocket 96 and a large sprocket 100. An idler sprocket 102 is suspended by a hangar 104 from a plate 106 extending between the long rails 60 and 62. Large sprocket 100 is driven by chain 98 and a shaft 108 connects the center of the sprocket through a coupling 110 to a shaft 112. Shaft 112 is fixed to and projects downwardly from a plate 114 that is welded or otherwise affixed to a plate 116 fixed beneath the bed 12 of the trailer 10.

Shaft 112 projects downwardly through a hole 118 provided therefore through a steel plate 120 that is fixed to long rails 60 and 62. Thrust bearings 122 have housings welded, or otherwise affixed to steel plate 120. The thrust bearings are equidistant from the shaft 112 and are on a circle surrounding the shaft 112.

Plate 116 rests on the balls of the thrust bearings and when the bed 12 is turned the plate 114 turns on the bearings.

Operation of motor 90 turns small sprocket 96 and drives chain 98 to turn large sprocket 100 and through shafts 108 and 112 and plate 114, bed 12 of the trailer. Motor 90 is a DC motor, powered by the battery of the tow vehicle. Wires 124, connected to motor 90 and to a connector 126 allow the motor to be coupled to the tow vehicle. A switch 126 is also connected in the wires 124 to allow the motor to be turned on and off. Switch 124 is preferable mounted on tongue 50, but it will be apparent that the switch could be mounted elsewhere.

A locking plate 130 is pivotally connected at 132 to front rail 52 of undercarriage 54 and hangs from the pivot connection. A handle 134 projects from locking plate 130 and is used to pivot the locking plate to a position where a portion 136 of the locking plate overlaps the front edge 20 of bed 12 to prevent rotation of the bed. A pin 138 is inserted through aligned holes in the front rail and the locking plate. A small spring clip) 140 through the end of pin 138 holds pin 138 in place to prevent undesired turning of the trailer bed 12.

With the rotating bed 12 trailer 10 can be conveniently used to load and unload snowmobiles, or all terrain vehicles, at any desired angle with respect to the trailer undercarriage. The bed is merely turned to the desired angle with respect to the fixed undercarriage and the ramp 42 is lowered to permit the vehicle to be driven onto the trailer bed. After loading the bed 12 ramp 42 is again pivoted to its raised and locked position and the bed is rotated to be aligned with and locked relative to the undercarriage. The, bed is turned to a desired angle relative to the undercarriage and ramp 40) is lowered to permit the vehicles to be driven from the bed 12. Ramp 41) is then raised and locked in place.

Although a preferred embodiment of my invention has been herein disclosed, it is to be understood that the present disclosure is by way of example and that variations are possible without departing from the subject matter coming within the scope of the following claims, which subject matter I regard as my invention.

1. A trailer for snowmobiles comprising
a flat trailer bed to receive at least one snowmobile thereon;
a wheeled undercarriage provided beneath said bed;
bearing means carried by said undercarriage and supporting said bed, whereby said bed will rotate on said bearing means relative to said undercarriage;
drive means carried by said undercarriage to fully rotate said bed relative to said undercarriage; and
control means to operate said drive means.

2. A trailer as in claim 1, further including
ramp means at a front and a rear of said trailer bed providing means for driving a vehicle on said ramp means at a rear of said trailer bed onto said bed and on said ramp means at a front of said trailer bed off of said bed.

3. A trailer as in claim 2, wherein the drive means includes
a motor having an output shaft said motor being mounted to the undercarriage;
a sprocket secured on said output shaft
a shaft having one end fixed to the trailer bed and extending downwardly therefrom;
a sprocket on the end of said shaft remote from said trailer bed; and
a chain extending around and meshing with said sprocket on the output shaft of said motor and said sprocket on the end of said shaft extending downward from said trailer bed, whereby operation of said motor will rotate said trailer bed relative to said undercarriage

4. A trailer as in claim 3, wherein
the motor is an electric motor; and further including
electrical connector means for connecting said motor to a tow vehicle for said trailer.

5. A trailer as in claim 4, further including
a switch in said electrical connector means to turn said motor on and off to thereby rotate the trailer bed relative to the undercarriage.

6. A trailer as in claim 5, further including
means to lock said undercarriage to said trailer bed with the front ramp at a front edge of the undercarriage.

7. A trailer as in claim 6 wherein the bearing means includes
a steel plate fixed to the trailer bed;
a steel plate fixed to the undercarriage;
a plurality of spaced apart thrust bearings fixed on a circumference having the shaft projecting downward from the trailer bell to the sprocket as a center and fixed to said steel plate that is fixed to said undercarriage and said bearings each having a bearing surface supporting said steel plate fixed to said trailer bed.
